(19) United States
(12) Patent Application Publication
(10) Pub. No.: US 2003/0182639 A1
(43) Pub. Date: Sep. 25, 2003

(54) Circuit simulator system and method

(75) Inventors: Timothy S. Lehner, Hopewell Junction, NY (US); Vasant B. Rao, Fishkill, NY (US)

Correspondence Address: IBM MICROELECTRONICS, INTELLECTUAL PROPERTY LAW, 1000 RIVER STREET, 972 E, ESSEX JUNCTION, VT, 05452, US

(73) Assignee: International Business Machines Corporation, Armonk, NY (US)

(21) Appl. No.: 10/063,142

(22) Filed: Mar. 25, 2002

(51) Int. Cl. G06F 17/50

(52) U.S. Cl. 716/4

(57) ABSTRACT

A transistor-level simulator system and method which uses a simulator=s API=s construct a circuit code module which is used to perform circuit simulation of input and output wave forms without the user having to provide a detailed netlist. This circuit simulation tool may be used on more complex gates where other models may be impractical to obtain without loss in the fidelity of the waveforms.

### BACKGROUND OF THE INVENTION

This invention relates to methods and systems used for generating behavioral models used in integrated circuit design. More particularly, the present invention provides for a new behavioral model that provides timing, noise and integrity grid analysis.

When simulating I/O electrical performance during timing characterization, signal integrity analysis, and power grid integrity analysis, various I/O modeling techniques have been used. At one end of the modeling spectrum are the full netlist models that contain detailed architectural and parasitic information of the I/O. These models provide the highest level of accuracy and can be used for a variety of analysis. A major disadvantage of full netlist models are excessive simulation times that prohibit them from being used at the chip level and non-convergence under certain conditions. At the other end of the spectrum are empirical models for driver delay and IBIS models for signal integrity analysis.

Empirical models use simple equations or lookup tables for predicting driver delay and output slew rate. The advantage of empirical models is fast simulation time. The disadvantages are poor accuracy under certain conditions, and they are typically limited to timing analysis. For signal integrity analysis IBIS models can be used. The advantage of these models are accurate driver output waveforms across a wide range of loading conditions. The disadvantages are they cannot be used for timing analysis and the models do not predict driver sensitivity to variations in supply voltage, temperature, and input slew rate.

I/O behavioral modeling in the form of IBIS models has gained wide acceptance in signal integrity analysis. While the IBIS model accurately represents the characteristics of the output pin at three fixed process corners, it does not model driver delay or account for variations in temperature, supply voltages, and input transition rate. The IBIS models used today by various board level simulation tools for signal integrity analysis are behavioral in nature and offer the user and developer of the models several advantages over full-netlist models. First, because IBIS models are behavioral, they contain no proprietary information. This makes it easy to exchange information about I/O characteristics without disclosing intellectual property. Second, behavioral simulation is faster than full-netlist simulation (e.g., Spice) because it uses higher-level abstraction models. What would be prohibitive in terms of simulation time when using full-netlist models can be accomplished in reasonable time with behavioral models.

The IBIS specification (ANSI/EIA-656-A, “I/O Buffer Information Specification (IBIS) Version 3.2”, September 1999), presents several techniques for improving model accuracy across a wide range of I/O family types for signal integrity analysis. I/O behavior modeling (e.g. IBIS I/O Buffer Information Specification) have been used by industry in PCB level signal integrity tools such as SpectraQuest from Cadence and XTK from Viewlogic for several years.

The design of integrated circuits often requires electrical analysis through circuit simulation. In a number of applications, such as noise analysis, full waveform information is necessary. Specifically, the circuit, and the underlying model representing the circuit, must be fully sensitive to the input waveforms (voltage traces) and must generate fully detailed output waveforms.

The models used to represent the circuits being analyzed must also be reusable and relocatable in the design, and therefore sensitive to the physical context in which the circuit is placed. Specifically, the model used to represent the circuit to be analyzed must properly account for the loading of the output pins of the circuit.

Traditional behavioural models are context-sensitive and encapsulating, but do not provide full waveform-input sensitivity and full waveform output. Rather they characterize the waveform by a small number of values of direct interest to the type of analysis being performed. This specificity narrows the usefulness of the model to one particular type of analysis and is additionally generally insufficient for any type of analysis which requires a detailed waveform output, or full sensitivity to input waveforms, an example of which is noise (signal integrity) analysis. Traditional behavioural modeling is accomplished by some amount of simplification of the topology of the original circuit, and replacement of the original circuit's constituent components.

Traditional simulation methods provide full I/O waveform sensitivity and capability, but require the availability of a fully detailed “netlist”, specifying the underlying topology of the analyzed circuit, as well as the details of the constituent devices. The full circuit topology is present during simulation. Transistor-level analysis is also not “modular” in the sense of a well-defined interface between the circuit of interest and the rest of the circuit being simulated.

At present, the waveform input-sensitivity and the accurate waveform output needed for applications such as noise analysis are available only through the use of transistor-level simulation. This in turn requires the availability and use of a “flat” (or flatten able) circuit netlist, consisting of a complete specification of the circuits to be analyzed, including their internal topologies. This flat circuit occupies an amount of RAM memory and disk-space which can prohibitive, resulting in those cases in an inability to undertake the type of analysis desired. Moreover, there are a number of situations in which a flat (transistor-level) circuit specification is simply unavailable for any of a number of reasons relating to the data flow inherent to the design process or a need to maintain the confidentiality of proprietary information about these circuits, such as when customers external to the corporate entity designing the circuits have a need to analyze the circuits in a post-placement situation. Even in those circumstances when transistor-level design specifications are available, the run-time required for simulation can be unacceptably long or outright prohibitive.

### BRIEF SUMMARY OF THE INVENTION

This invention simultaneously addresses these three requirements: waveforms I/O's, context (load) sensitivity, and encapsulation (detail hiding). Moreover, this invention accomplishes these three goals with speed and accuracy sufficient for timing, noise, or other types of detailed electrical analysis, as illustrated in FIG. 1. The input to the model must consist only of the input waveforms and the output load, while the output consists only of the output pin's voltage waveform. All others details of the circuit must remain invisible.

An alternative approach is also provided in which an API-driven detailed transistor-level simulator will be used under the covers to perform the simulation without the user having to provide the detailed netlist. This alternative approach may be used on more complex gates where the proposed “simplified” model may be impractical to obtain without any significant loss in the fidelity of the waveforms.

This invention provides a method of specifying a model which will rapidly and faithfully reproduce during simulation the original circuit's behavior. This model meets the three objectives of: I/O waveforms, context-sensitivity, and encapsulation/topology-hiding

The elements present in the basic model are capacitors and ideal current sources, the latter providing a high level of generalizability by not being directly restricted to real (physically derived) device or circuit currents. This allows for arbitrary manipulation of these currents as mere mathematical conveniences rather than being rigidly tied to physical effects, for example by introducing a time or voltage delay into the values of current used. The adaptability and accuracy of the model is made possible by explicitly tabulating all element values as simultaneous functions of all input and output voltages, and using a high-dimensional interpolation technique of arbitrary order. The topology chosen is the simplest one that still shows the necessary qualitative features and allows for simple generalization to multiple input/output pins. The high level of accuracy is added to by the implicit nature of the ordinary differential equation (ODE) used to solve for the output voltages. The lookup, via interpolation, of precomputed values and the simple structure of the implicit ODE significantly speeds up the simulation process.

This invention also provides a method of generating the models for circuits with simple topology, models which can be used by our simulation technique, although the simulation method may use models derived by other approaches.

### BRIEF DESCRIPTION OF THE DRAWINGS

FIG. 1 is a circuit schematic illustrating the requirements and use of the behavioral model.

FIG. 2 is a circuit schematic which illustrates the basic model provided my this invention.

FIG. 3 is a circuit schematic which illustrates a simple pi model.

FIG. 4 is a circuit schematic which illustrates an example of a parameter extraction setup and methodology.

FIG. 5 circuit schematic which illustrates a model in which the ‘p’ and ‘n’ current sources are combined.

FIG. 6 is a block diagram which illustrates how the invention obtains the actual output waveform values.

FIG. 7 is a schematic block diagram illustrating the use of an API simulator to construct a circuit which can be used in simulation.

FIG. 8 is a schematic block diagram of a general-purpose computer for practicing the present invention.

### DETAILED DESCRIPTION OF THE INVENTION

The physical context for the use of encapsulated circuit models is illustrated in FIG. 1. FIG. 1 illustrates a single behavioral model for ‘circuit A’ which allows for and is sensitive to any input waveform, any output loading and exhibits no internal details. The inputs to ‘circuit A’ are thus only the input waveforms and the output load. The output from circuit A is only the voltage waveform at the output pins.

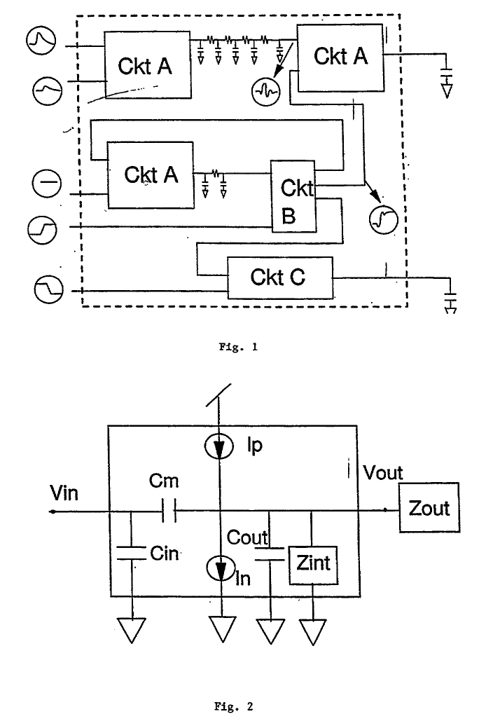

FIG. 2 shows the basic model topology and elements. A CMOS circuit can be represented in its simplest form by a p-block connecting the output node to the supply rail (Vdd) and an n-block connecting the output node to the ground rail (gnd). (Note: the concepts for the model can also be applied to other process circuit types such as bipolar circuits. However, for these types of devices it may be better to use current waveforms versus voltage waveforms.) These are represented by idealized current sources (Ip, In, respectively). There is one (Ip, In) pair per output node. The current values supplied by Ip and In are assumed to be full functions of all input voltages (Vin) and output voltages (Vout). In common mathematical notation: Ip({Vini}, {Vouti}), In({Vini},{Vouti}).

Additionally, in order to represent the input-to-output capacitive effects, the model includes a “Miller” capacitor Cm, also assumed to be a full function of all input and output voltages: Cm({Vini},{Vouti}). There is one Cm per input/output pin pair. Similarly, the input-pin-to-ground capacitor (Cin), of which there is one per input pin, is a full function of all input/output voltages Cin({Vini},{Vouti}), as is the ouput-pin-to-ground capacitor: Cout({Vini},{Vouti}), of which there is one per output pin. The model also has an internal impedance Zint, again assumed to be a function of all Vin's and Vout's. Zint allows one to account for the internal node capacitance without requiring detailed information about the internal topology of the circuit.

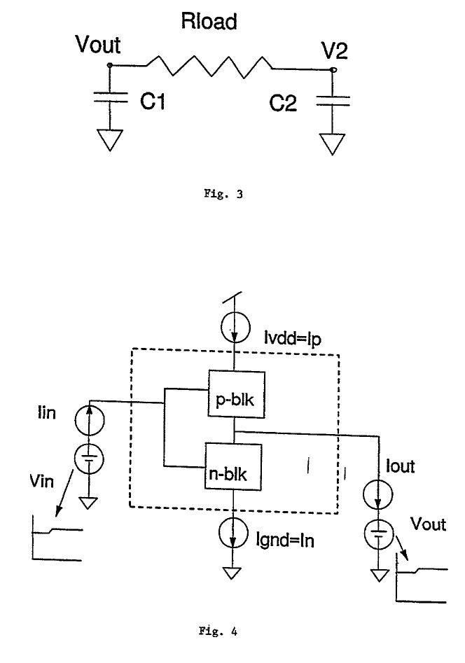

The output pin loading (Zload) is not part of the model per se, as it depends on where the circuit will be placed in the context of the larger design, but its presence and details are allowed for by one of two methods. The first method is the crudest and fixes the topology of Zload to be that of a static load model or a “pi model”, as seen in FIG. 3. The parameters of the pi model (C1, Rout, C2) are passed in by the calling program/user through the interface. This will provide a simple way to describe the loading network, sufficient for many applications and requiring little work on the part of the caller, be it a human or another computer program. This first method will result in explicit terms in the obtained ODE (equation 2, below) which one uses to solve for the output voltage(s). The second method of accounting for the effect of output load on the output pin is more accurate but requires more work on the part of the caller. In this second approach, a general current term (Iload) is simply subtracted from the numerator of the right-hand-side of the ODE representing the circuit's behavior as seen below in equation 1. It is then up to the caller to provide a call-back function which will indicate to the ODE solver how much current is drawn into the load-circuit at each time point and output voltage. At each time point at which the output voltage is solved for, the solver will issue a request to the caller, providing the time and the voltage of the output node and asking the caller to give back the current Iout drawn into the load-circuit.

Given the model detailed above, one can derive a simple, implicit, ordinary differential equation (ODE). The implicit nature of the ODE means that the output voltage which one solves for is present in the right-hand-side of the ODE (through the dependence of all ‘I’ and ‘C’ terms in the right-hand-side on Vout; recall that all those are functions of all Vin's and Vout's). This has the effect of greatly improving the accuracy of the solution arrived at for the output node voltage, and obviating the need for the explicit timing of the delay of the signal across the circuit which is needed in explicit models. The ODE is arrived at by solving for current continuity at each output node:

dVout/dt=(Ip−In+(Cm*dVin/dt)−Iload−I(Zint))/(Cout+Cm) (Equation 1)

If a pi-model of the output load is used, the Iload term is determined by a pair of equations:

Iload=dVout/dt*C1+(Vout−V2)/Rload Equation 2a

dV2/dt*C2=(Vout−V2)/R Equation 2b

Where the parameters C1, C2 and Rload are constants, provided by the caller. V2 in the above equation starts out being equal to Vout at the beginning of simulation.

The ODE represented by equation 1 can be solved numerically by a variety of common methods. The inventors used both the fourth-order Runge-Kutta’ method as well as the ‘trapezoidal’ method. Both have strengths and weaknesses, but work adequately within those limitations. The same holds true for the many other methods available to solve such equations.

Having evaluated and stored values of the parameters in question for all input and output voltages in a certain range, one has a ‘hyper-grid’ (grid in potentially more that two-dimensional space) of said parameter values at discrete values of all input and output voltages. When solving the ODE, one will need values of the parameters of the ODE at a large number of input/output voltage points, which in general will not coincide with the hyper-grid points at which values are known. To obtain the value of parameters at the desired values of input/output voltages, interpolation in that hyperspace (of dimension of the number input and output ports) is undertaken. The interpolation can be accomplished by any of several common techniques. The order of the interpolation is variable, with lower-order methods being faster but potentially less accurate, and higher-order methods slower but potentially more accurate. First and third order (local) interpolations and (global) cubic spline interpolations were used. They performed reasonably, as would any other arbitrarily-dimensioned interpolation technique, within the known limitations and advantages of each interpolation method.

By virtue of the chosen topology of the model, extension to multiple input or output pins is straightforward. Each output is assigned its own Ip, In and Cout. Each input is assigned a Cin. With each input/output pair is associated one Cm capacitor. Since all parameters are implicitly functions of all input and output voltages, no further explicit generalization need be done. The dependence of outputs on inputs will automatically rise out of the parameter extraction process. For each output, we will have a separate ODE which can be solved independently of the ODE representing other outputs. This is possible due to the implicit dependence of all parameters on all input and output voltages.

This invention requires values of the model's parameters to be extracted for all relevant combinations of input and output voltages. That is to say, for some set of combinations of Vin's and Vout's, one must measure and store values of all the parameters used in the model. Moreover, the range of the Vin/Vout voltages should encompass all voltages which are likely to present themselves on those pins. Failing that, provisions should be made in the parameter-lookup function to extrapolate parameters from outside of the stored range. In point of fact, any set of {Vini, Voutj} n-tuplets can be selected for measurement and storage, provided that from those stored data one can provide a full set of parameter values (I's and C's for example), given a set of actual input/output voltage values (which will in general not coincide with the stored values). The method of selecting, measuring and storing parameter values, along with the interpolation method for reconstructing parameter values at simulation (ODE solution) time may have an effect on the speed and accuracy of the final output voltages, as well as the time and storage space required to perform the parameter extraction.

One example of how one might extract the parameters for use with this model is provided. It is important to note that this is merely one example of a possible extraction methodology, suitable for circuits with simple topology, such as static logic gates. The exact method of extracting parameter values depends heavily on the type of circuit one wishes to model, its topology in particular.

In this example of an extraction methodology, another simulator is used to perform measurements. This simulator should have a level of accuracy higher than that wished to be obtained by using the basic model to perform simulation. One example of such a simulator is any SPICE-like simulator, whose use is described in the rest of this section. However other simulators could be substituted without impact to the model proposed by this invention, save for issues of accuracy and speed. The circuit used in the extraction process and the underlying device models must contain all topological, dimensional and technological details relevant to its accurate simulation. This is the only place that the circuit details are needed.

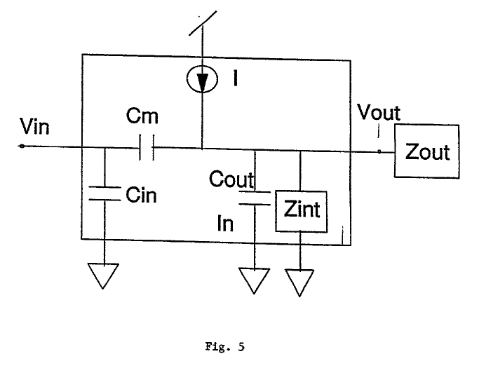

The first step is to take the detailed, original circuit to be modeled, and, in the SPICE-like simulator, connect ideal grounded voltage sources to all input and output pins. The next step is to monitor the current flowing through those voltage sources. Additionally, one connects the zero-valued voltage sources between ground and the common, formerly grounded node of the devices, and another such zero-valued voltage source between the supply rail and the formerly Vdd-connected device terminals. These will allow one to monitor the ground (Ignd) and Vdd currents (Ivdd). This setup is shown in FIG. 4. The next step is to select the range that each voltage source will scan across, which should cover the voltage range over which one hopes to simulate, commonly from slightly below ground to slightly above Vdd. One then selects how to sample across all these ranges, the simplest method being to uniformly step across the selected range for each pin, in nested loops. one loop per pin. In each instance of a selection of pin voltages, one measures the steady-state current flowing into/out of the pins. This provides you with the Ip and In currents, at that set of pin voltages, since the following equations apply:

Ip=Ivdd (Equation 4a)

In=Ignd (Equation 4b)

The next step is to apply small voltage changes to the values of the voltage sources at the pins. The change should be small enough to not substantially change the operation point of the devices, and fast enough to produce sufficiently large capacitive currents, according to equation 5, below. Given that one can perform this type of measurement a number of times with a number of different voltage change rates/directions of the voltage perturbation, that the pin voltages (Vin, Vout) are controlled by the voltage sources, and that the pin currents (Iin, Iout) are monitored, one can solve for the capacitance values Cin, Cm, Cout in the following equation:

Iin=Cin*dVin/dt+Cm*d(Vin−Vout)/dt (Equation 5a)

Iout=Cm*d(Vin−Vout)/dt−Cout*dVout/dt (Equation 5b)

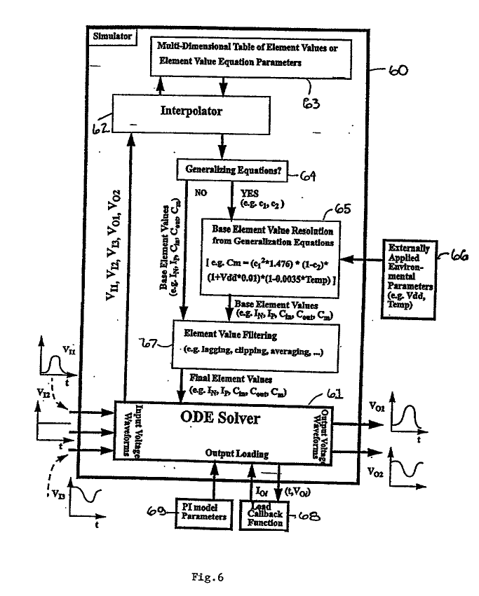

There may be circumstances in which it is difficult or impossible to separate out the ‘p’ and ‘n’ current sources (Ip, In). In those or other situations, it may be desirable to combine the current sources into a single current source, which would drive current into the output node, as shown in FIG. 5. This current source would still be assumed to be a function of all input and output voltages, and extracted as such. The effect on the ODE would be to modify it to become:

dVout/dt=(I+(Cm*dVin/dt)−Iload−I(Zint))/(Cout+Cm) (Equation 6)

The details and structure of the internal impedance labeled Zint can also change without fundamentally changing the nature of the ODE, or the method by which a solution is arrived at. Whatever implementation of Zint is chosen, the current flowing into Zint, namely I(Zint), can change continuously as a function of time, and is thus different at every time point. Consequently, one or more additional equations will enter into the solution of the ODE, as the current I(Zint) will be given by the solution to these equations, rather than as a simple term in the ODE. For example, if the topology chosen for Zint were a pi-model, there would need to be a pair of equations similar to 2a and 2b whose simultaneous solution yielded the current I(Zint) at every ODE-solution time step. Thus the choice of a model for Zint will affect the specific form of the ODE by introducing ancillary equations to be solved, but does not change the basic method of the invention. For many modeled circuits, it has proven unnecessary to have any internal impedance model at all. Having no internal impedance in the model has the same effect as saying that the current drawn by the internal impedance is identically zero (I(Zint)=0) at all times.

The stored current or capacitance values can be modified or manipulated mathematically as part of the parameter lookup and ODE solution step, in any of a number of ways which improve the accuracy of the final solution. By way of example, in one implementation of this method it was useful to introduce a time lag in the Ip current. In another, a voltage-based lag of Ip was effective in improving the accuracy. Any arbitrary mathematical manipulation of the raw extracted data may be used without substantively affecting the method and model presented.

Similarly, and significantly, other explicit dependencies of the parameters could also be added without affecting the method of this invention. By way of example, the parameters could be made to explicitly depend on time or even on another parameter, either present in the basic model, or an external parameter. Examples of the latter would be to parameterize all voltages by Vdd, the supply voltage, or parameterize them by the temperature, or another technological parameter, each of which would be an externally specified value. In short, one can add explicit dependencies of the model parameters without changing the fundamental method of the invention nor eliminating the implicit character of the ODE, which provides many of its benefits (an implicit equation to which is added explicit dependencies is still implicit). This can significantly generalize the range of applicability of these models, in a manner similar to that described in the paper authored by J. D. Hayes and L. Wissel, “Behavioral Modeling for Timing, Noise, and Signal Integrity Analysis,” IEEE Custom Integrated Circuits Conference, pp. 353-356, 2001, allowing a single model to account for variations in supply voltage, temperature, process variability factors, or other parameters. These explicit parameters would be used in conjunction with the interpolation, in a step taking the interpolated parameter values, the explicit (externally specified) parameters and use both to arrive at final values of the physical parameters of interest, such as current and capacitance. In this generalization of the model and method of this invention, the values stored need no longer be actual currents or capacitances, although they could be. One would have the option of storing an abstract parameter in lieu of a current or capacitance, said parameter being such that it permits, in conjunction with the externally specified parameters, the calculation of the actual parameter value.

The interpretation of the input waveforms can be changed from voltage traces to current traces without fundamental change to the method. Since the method only depends on the ability of the lookup/interpolation step to generate drive currents and capacitances (or parameters which can be used to ultimately obtain those quantities), the input data can in fact be any n-tuplet that results in a unique value from interpolation or extrapolation of the stored, previously measured data.

The interpretation of the output waveforms can change without change to the methods of this inventions from that of voltage signals to current signals with the addition of a single step after the Vout voltage trace is arrived at. Specifically, provided Vout is solved for, the output current lout is given by the closed-form expression of equation 5b. This step does assume that the input voltage signal (Vin) is known or can be reconstructed from the input data.

Without fundamental changes to the method, other passive devices (resistors, inductors) could be added to the basic model to represent additional physical current or voltage effects. One example of such a change would be to model gate leakage current by adding a resistor (Rg) connecting the input pin to the output pin, in parallel with the Miller capacitor. This and other such changes would have an effect on the ODE. In the example just mentioned, there would appear an additional term in the ODE, as seen below:

Vout/(Rg*(Cout+Cm))+dVout/dt=(Ip−In+Vin/Rg +(Cm*dVin/dt)−Iload−I(Zint))/(Cout+Cm) (Equation. 7)

In contemporary CMOS circuits, this term can usually be ignored (i.e. Rg is infinite) without significant impact on accuracy. In the future, or in different circuit types, this may not be the case. The introduction of this additional effect will slow down the solution of the ODE and should thus be introduced only when absolutely needed.

Without fundamental change to the method of this invention, there may also be circuits in which there are no transistors of one of the two types (‘p’, or ‘n’). In that case, that current (Ip or In respectively) is identically zero, or otherwise stated, the element is removed from the model, leaving an open-circuit connection.

The method or order of parameter inter/extrapolation can also be modified without changing the fundamental method of the invention, as can the range and selection of extracted parameter values.

The method used to solve the ODE(s) can be changed without fundamental change to our method.

In summary, the following steps are undertaken with the three part goal of creating a behaviorally equivalent circuit which: 1) accepts and uses fully detailed input waveforms and produces fully detailed output waveforms; 2) hides the internal details and topology of the circuit; 3) is sensitive to ‘environmental’ conditions, most notably the load attached to the output at which the output waves are generated: (There are also some implicit goals that the model will simulate quickly relative to the original circuit, while maintaining a high level of voltage waveform fidelity.)

The first step is to provide an equivalent model which is topologically very simple.

The model consists only of 1 or 2 current source elements and a few passive elements (capacitors in the basic model). If the ‘N’ and ‘P’ blocks are kept separate (the model first presented), there is one current source for each block. If the ‘N’ and ‘P’ blocks are merged, there is a single combined current source. The passive elements comprise 3 capacitors, but could also include resistors, or inductors. This basic topology determines the equation describing the model's behavior. This equation is an ordinary differential equation.

The second step is to translate the model into an equation which is implicit with respect to the output voltage(s) solved for, and differential in nature.

In the model this means that the determination of the output voltage must take its own voltage into account for self-consistently. (E.g.: x=sin(x)).

The third step make measurements of the model element values, at ‘all’ values of all I/O node voltages. This step is necessary since the inventions assumes all element values depend on all I/O node voltages. The input node voltages are also explicitly functions of time, as given by the input voltage waveforms.

In this methodology ‘All’ means as wide a range as is necessary and practical given speed and accuracy constraints and the interpolation method to be used in #5 below, but preferably the coverage should cover the entire possible range of I/O node voltages.

If one is modeling a circuit with 3 inputs and 2 outputs, an output capacitance C would be a function of all 5 I/O node voltages: i1, i2, i3, o1, and o2. Furthermore, the input node voltages i1, i2, and i3 are themselves functions of times, as determined by their waveforms. This is how the input-waveform dependence and sensitivity comes into the method. Mathematically, this is represented by: C(i1(t), i2(t),i3(t),o1,o2).

There is no constraint that the element values be physically realistic. The elements, although represented in the model as physical objects, are allowed to have take whatever value is most useful for accurate/fast simulation of model. This is in contrast with others' work of arriving at ‘equivalent circuits’ which are based on real physical devices. In this current source method there are variations on the proposed topology which do not substantively change the approach: each (N, P) current source could be spit up into an arbitrary number of parallel current sources, each of which could depend on a different but potentially overlapping set of inputs, in addition to the output of interest. This might reduce the number of sampling points needed to construct the database (table), but doesn't change the basic approach. The current from each source are simply summed in this case.

In the fourth step one can (optionally) generalize the model by not storing the model elements directly, but rather storing parameters of equations which can be solved to give model element values. These parameters are derived from one (or more) set(s) of measurements (#3 above) and requires the selection of a form for the equation.

This generalization allows external parameters (e.g.: temperature, Vdd) to enter into one (or more) equation per model element value along with the parameter which is measured for the model element values. By way of example, a series of measurements is made and it is determined that an certain output capacitance is given by the solution of:

C=SQUARE(c1(i1,i2,i3,o1,o2)*1.495*(1+Vdd/10.0)*(1−Temp/2000)

where c1 (i1,i2,i3,o1,o2) is a parameter (not a capacitance) which depends on all input/output voltages: i1,i2,i3,o1,o2 (per point 3 above), and Vdd is the voltage supply and Temp the temperature specified by the user at simulation time.

One could then store the c1 at many different combinations of (i1,i2,i3,o1,o2), and the formula for C, and then be able to calculate the actual output capacitance C for all values of Vdd and Temp. There is no upper limit on how complicated these equations could be. They could be differential, implicit, transcendental; there could also be multiple coupled equations solved simultaneously for a single actual model element value.

In the fifth step one resimulates the model given input waveforms and output loading.

As illustrated in FIG. 6 resimulation 60 consists of solution of our implicit ODE equation through common numerical techniques, with four important sub-steps, relating to: (1) the implied dependence of all element values on all I/O voltages; (2) the mathematical interpretation of our model element values (no constraining ties to a physical device); and (3) an optional method of obtaining the output load behavior.

The first sub-step is the interpolation of all element values (or parameters if generalization is used) in space of all I/O node voltages.

Interpolation in Interpolator 62 can be of any user-specified order. As stated above Interpolator 62 obtains the values of parameters at the desired values of input/output voltages, V hyper space (of dimension of the number input and output ports) is undertaken. The interpolation can be accomplished by any of several common techniques.

The second sub-step is the application of generalization equations (if any) using interpolated parameters and externally specified environmental parameters, and the equation chosen as part of optional step 4 above.

The third sub-step is the mathematical manipulation (filtering) of element values (eg: time or voltage-threshold-based delay, averaging, clipping, etc.).

In the fourth sub-step, at each time step, the ODE solver must call the callback function requesting the load current, after providing to the callback function the time, and output node voltage. This option is used only if the simpler static model such as pi-model or single capacitor value is not used for this output.

When the circuits in the circuit library are more complex there is an alternative approach that uses an detailed circuit simulator with API's (such as CSE from Circuit Sematics Inc.) in such a way that the user does not even see the details of the circuit topology or device geometry. By using the API's and libraries whether static or dynamic one can create an entire system for simulating a circuit. For example, one high performance way this can be is achieved by running a simulator with API's under a “Nutshell” environment wherein various applications are loaded in as “dlls” (dynamically loadable libraries) on an as needed basis.

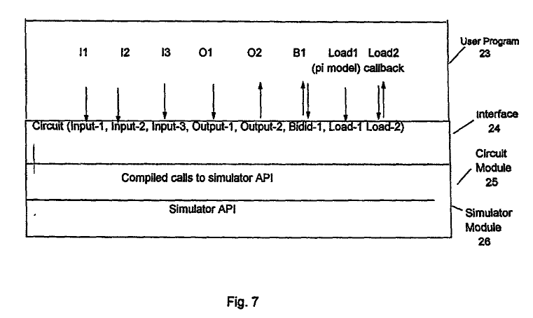

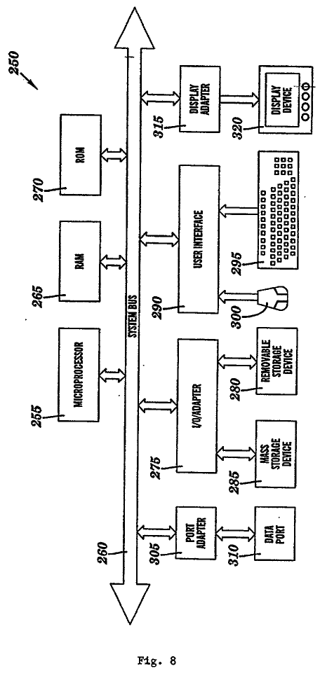

An ‘API’ (Application Programing Interface) is a set of elementary, ‘building block’ function calls which enable a certain type of operation or programing to be done. In the case of an API-based simulator, these are functions such as adding a transistor, capacitor or resistor to a circuit, applying voltage signals to pins, current through elements, retrieving voltage or current signals from elements, etc. Referring to FIG. 7, the calls made to the simulator as part of constructing a circuit to be simulated can be instantiated and packaged together, and an interface added to form an isolated circuit code module 25. This code module 25 can then be compiled, producing a binary (thus ‘hidden’) code module. When this code module is linked with the simulator module 26, in which the simulator API functions are defined, a complete computational package is available. Thus for simulation only the inputs shown as I1, I2 I3, O1, O2, B1 and Load defined as part of the interface of the circuit module are required.

Although modules are dynamically loaded in the inventors preferred embodiment, they need not be. The linking/loading could be either static or dynamic. In the latter case, there are library's (two: one for the circuit and another for the simulator). In the former case there is just a single static binary object.

The hierarchy for this process is simple. The user program 23 defines the inputs (I1,I2, I3, B1, etc.) and reads outputs (B1, O1, O2, etc.) from the code module 25.

The program interfaces to the circuit library (code module 25) for the actual inputs to the circuit, outputs from the circuit (e.g.: I/O voltages, I/O pin loading, temperature, Vdd). This provides one with a recorded, compiled group of function calls to the simulator API.

The simulator API is a definition of elementary functions used to construct, simulate and get results out of a circuit. The simulator module 26 is a compiled group of function calls to the OS and machine instructions.

The API-driven detailed circuit simulator is first loaded in as a library (e.g.. “sim.dii”). Each complex circuit type is modeled as a “function” whose internals are described using the simulator's API. As an example, consider a 2-input XOR gate implemented using pass-gates and internal feedback. Suppose the inputs are “a” and “b” and the output is “o”. Then one can implement a C++ function prototype:

SIM_Wave *IBM_ASIC_XOR_A(SIM_Wave *W_a, SIM_Wave *W_b, float C_o);//Simple load cap at Output

SIM_Wave *IBM_ASIC_XOR_A(SIM_Wave *W_a, SIM_Wave *W_b, float Cnear_o, float Rpi_o, float Cfar_o);//PI-model at Output

The inputs to this function are the detailed waveforms (class SIM_Wave, for example) at the circuit inputs and a load description (either a simple capacitance, a pi-model or some other static load model, or a call-back function) at the circuit outputs. The load model need not be restricted to a pi model or a simple capacitance. As in the ideal current source model method, it could be any other static load model, or even a dynamic call-back function. The interface call prototype would reflect the choice of load-modeling as the load is an input into the circuit module. The call-back function allows for the user or calling program to represent the load in whatever manner it sees fit, a very useful feature when one thinks of embedding these models in a multi-vendor methodology, where the circuit model and the load model may come from different vendors. The invention does not provide for the call-back function (the user does), but rather the prototype(s) of the call-back(s) function and sufficient documentation to further explain it. Also, the invention could potentially have more than one call-back interface (prototype).

The output of this function is the detailed waveform generated by the simulator at the circuit output specified. The body of these functions is a detailed description of the circuit elements and commands to run the simulation using the simulators API. In the above example, “A” stands for the “power level” or one type of implementation of the XOR gate. One could also have several such C++ functions, called IBM_ASIC_XOR_B, IBM_ASIC_XOR_C, etc. each being an XOR gate but implemented with different transistor sizes or even different transistor topologies.

The real advantage in this approach is that the “function” itself can be compiled into a library module by the circuit library team and need only be called by the Noise/Timing Analysis tool at run time to obtain the output waveform. Only the circuit library team needs to know the detailed circuit topology in order to create the source code (in the simulator API language) for each of these functions. Since this library module is a binary (machine coded) file, the internals of the specific circuit is hidden from the user. All the user has to do is simply load the individual libraries of all the circuit types that are contained in the design being run. Note that each of these libraries exports the functions that the user can call at run-time without having to know anything about the complex gate that is being simulated.

Of course, the prototype and argument list of each of these functions needs to be communicated to the user separately, for example, using a “header file” such as “ibm_asic_xor2.h” that looks something like:

#include <SIM_api.h>

//Power level A:

SIM_Wave *IBM_ASIC_XOR_A(SIM_Wave *W_a, SIM_Wave *W_b, float C_o);//Simple load cap at Output

SIM_Wave *IBM_ASIC_XOR_A(SIM_Wave *W_a, SIM_Wave *W_b, float Cnear_o, float Rpi_o, float Cfar_o);//PI-model at Output

//Power level B:

SIM_Wave *IBM_ASIC_XOR_B(SIM_Wave *W_a, SIM_Wave *W_b, float C_o);//Simple load cap at Output

SIM_Wave *IBM_ASIC_XOR_B(SIM_Wave *W_a, SIM_Wave *W_b, float Cnear_o, float Rpi_o, float Cfar_o);//PI-model at Output

//Power level C:

SIM_Wave *IBM_ASIC_XOR_C(SIM_Wave *W_a, SIM_Wave *W_b, float C_o);//Simple load cap at Output

SIM_Wave *IBM_ASIC_XOR_C(SIM_Wave *W_a, SIM_Wave *W_b, float Cnear_o, float Rpi_o, float Cfar_o);//PI-model at Output

where SiM_api.h is the header file for the simulator's API that contains all the function prototypes within that API that the external user can call.

The circuit library team writes up the detailed source files (e.g., “ibm_asic_xor2.C) implementing these functions in C++ using the simulators API and creates a “ibm_asic_xor2.dll”. The user is simply given the “ibm_asic_xor2.h” and “ibm_asic_xor2.dll”. In addition, the user needs to also load “sim.dll” which is the library that has all the simulators API calls implemented. With this information, the end user has no idea how the XOR2 circuit was designed by circuit library creator, what were the transistor sizes etc. But given the waveforms at the inputs and an appropriate load at the output, the user can call these functions to get the desired waveform at the output node.

The above example can be easily extended to XOR gates with 3, 4, 5, etc. inputs. The function prototypes will simply have additional arguments for the additional input waveforms. Next, the same thing can be repeated for other types of complex gates such as XNOR, MUX, LATCH etc. The circuit library creators can release headers and libraries individually for each gate type or club everything together and release only one “ibm_asic_gates.h” and “ibm_asic_gates.dll”. The choice of packaging these libraries is up to the creators.

Finally, this approach can be used for multi-output gates also. For example, consider a Clock Splitter which splits a single input (say “m_clk”) to two complementary outputs (say “b_clk” and “c_clk”). The function prototype for this gate could look like:

SIM_Wave *IBM_ASIC_CLK_SPLITTER(char *out_name, SIM_Wave *W_m_clk, float C_b_clk, float C_c_clk);

where the argument “out_name” could be either “b_clk” or “c_clk” to give back to the caller the waveform computed at that output node. Note that the user has to give the load at BOTH outputs even though he is interested in getting the waveform back at only one output at the time this function is called. Also, the simple load capacitances in the example above can be extended to 3-parameter Pi-models at each output. Clearly, this can be generalized for different power levels etc.

The clear advantage of this alternative approach is that arbitrary circuit topologies can be handled despite the fact that one is using a fairly general purpose circuit simulator like CSE from Circuit Sematics Inc., and no compromise in accuracy is made. A possible disadvantage is that this approach may be slower than directly solving the implicit ODE approach ideal current source model described above.

Generally, the method described herein with respect to model and IC is practiced with a general-purpose computer and the method may be coded as a set of instructions on removable or hard media for use by the general-purpose computer. FIG. 8 is a schematic block diagram of a general-purpose computer for practicing the present invention. In FIG. 11, computer system 250 has at least one microprocessor or central processing unit (CPU) 255. CPU 255 is interconnected via a system bus 260 to a random access memory (RAM) 265, a read-only memory (ROM) 270, an input/output (I/O) adapter 275 for a connecting a removable data and/or program storage device 280 and a mass data and/or program storage device 285, a user interface adapter 290 for connecting a keyboard 295 and a mouse 300, a port adapter 305 for connecting a data port 310 and a display adapter 315 for connecting a display device 320. ROM 270 contains the basic operating system for computer system 250. Examples of removable data and/or program storage device 280 include magnetic media such as floppy drives and tape drives and optical media such as CD ROM drives. Examples of mass data and/or program storage device 285 include hard disk drives and non-volatile memory such as flash memory. In addition to keyboard 295 and mouse 300, other user input devices such as trackballs, writing tablets, pressure pads, microphones, light pens and position-sensing screen displays may be connected to user interface 290. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 280, fed through data port 310 or typed in using keyboard 295.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A computerized simulation system for simulating an integrated circuit which comprises:
a computer system comprising an operating environment for computer applications;
a simulator module comprising API functions to construct, simulate and get results from a circuit and function calls for engaging the computer system;
a user program which executes on the computer system and allows a user to define circuit inputs and circuit outputs;
a circuit code module linked to the simulator module comprising an interface to the user program, packaged function calls for the circuit which is simulated and an interface to the user program

2. The system of claim 1 wherein the code module is compiled as dynamically loadable libraries and is linked to the simulator module through the dynamically loadable libraries.

3. The system of claim 1 wherein the code module is compiled as a static binary object.

4. The system of claim 1 wherein a load description is provided through the user program by a static load model.

5. The system of claim 1 wherein a load description is provided through the user program by a dynamic callback function.

6. The system of claim 1 wherein the packaged function calls comprise a description of circuit elements and commands to run the simulation using the simulator's API.

7. The system of claim 6 wherein the packaged function calls are compiled into libraries.

8. The system of claim 7 wherein the code module also comprises a dynamically loadable library containing instantiations of API simulator calls.

9. The system of claim 1 wherein each circuit type is modeled as a “function” whose internals are described using the simulator's API.

10. A method of using a circuit simulator to model a circuit, comprising the steps of:
providing a record of calls made to a circuit simulator during construction and setup of circuits;
packaging the recorded calls together into a circuit code module and adding an interface which can be called by a user program;
linking the circuit code module to the circuit simulator such that the user program can define inputs, outputs and loads for the circuit; and
inputting through the user program the input, output and load of the circuit which is to be modeled.

11. The method of claim 10 wherein the circuit simulator has an API interface and the code module has API calls implemented within the module.

12. The method of claim 11 also comprising the step of compiling the recorded calls and the code module as a library.

13. The method of claim 10 also comprising the step of providing a call-back function prototype to determine the load of the circuit.

14. The method of claim 11 wherein each circuit type is modeled as a function whose internals are described using the simulator's API.

15. The method of claim 11 also comprising the step of writing detailed source files for each circuit in a high level programming language using the API calls from the circuit simulator.

16. A program storage device readable by machine, tangibly embodying a program of instructions executable by the machine to perform method steps for using a simulator to model an IC, the method steps comprising:
providing a record of calls made to a circuit simulator during construction and setup of circuits;
packaging the recorded calls together into a circuit code module and adding an interface which can be called by a user program;
linking the circuit code module to the circuit simulator such that the user program can define inputs, outputs and loads for the circuit; and
inputting through the user program the input, output and load of the circuit which is to be modeled.

17. The program storage device of claim 16 wherein the circuit simulator has an API interface and the code module has API calls implemented within the module.

18. The program storage device of claim 17 wherein the method steps also comprise compiling the stored calls and the code module as a library module.

19. The program storage device of claim 16 wherein the method steps also comprise the step of providing a call-back function prototype to determine the load of the circuit.

20. The program storage device of claim 17 wherein each circuit type is modeled as a function whose internals are described using the simulator's API.
